(19) United States
(12) Patent Application Publication
(10) Pub. No.: US 2023/0202072 A1
(43) Pub. Date: Jun. 29, 2023

(54) RESIN PELLET, MANUFACTURING METHOD FOR RESIN PELLET, MOLDED PRODUCT, AUTOMOBILE PART, ELECTRONIC APPARATUS PART, AND FIBER

(71) Applicant: FUJIFILM Corporation, Tokyo (JP)

(72) Inventors: Masahiro HATTA, Shizuoka (JP); Masataka Oishi, Shizuoka (JP)

(73) Assignee: FUJIFILM Corporation, Tokyo (JP)

(21) Appl. No.: 18/178,526

(22) Filed: Mar. 5, 2023

Related U.S. Application Data
(63) Continuation of application No. PCT/JP2021/029693, filed on Aug. 12, 2021.

(30) Foreign Application Priority Data
Sep. 9, 2020 (JP) 2020-151557

(51) Int. Cl. B29B 9/12; B29B 7/00; B29B 9/10

(52) U.S. Cl. CPC B29B 9/12; B29B 7/002; B29B 9/10; B29K 2995/0097; B29K 2995/0017; B29K 2075/00

(57) ABSTRACT

The present invention provides a resin pellet that enables the molding of a molded product exhibiting a tensile breaking strength at the same level as that of a tensile breaking strength of a resin contained in the resin pellet, a manufacturing method for a resin pellet, a molded product, an automobile part, an electronic apparatus part, and a fiber. The resin pellet of the present invention contains a microcapsule encompassing a heat storage material and a thermoplastic resin, in which a content of the heat storage material is 70% by mass or less with respect to a total mass of the resin pellet, and a capsule wall of the microcapsule contains at least one resin selected from the group consisting of polyurethane urea, polyurethane, and polyurea.

### CROSS-REFERENCE TO RELATED APPLICATIONS

This application is a Continuation of PCT International Application No. PCT/JP2021/029693 filed on Aug. 12, 2021, which claims priority under 35 U.S.C. § 119(a) to Japanese Patent Application No. 2020-151557 filed on Sep. 9, 2020. The above applications are hereby expressly incorporated by reference, in their entirety, into the present application.

### BACKGROUND OF THE INVENTION

### 1. Field of the Invention

The present invention relates to a resin pellet, a manufacturing method for a resin pellet, a molded product, an automobile part, an electronic apparatus part, and a fiber.

### 2. Description of the Related Art

Microcapsules may be able to provide a new value to a customer in terms of encompassing and protecting functional materials such as a heat storage material, a flavoring agent, a dye, a curing agent for an adhesive, and a pharmaceutical drug component. In particular, a microcapsule that contains a phase change material (PCM) and functions as a heat storage material that stores heat generated outside has attracted attention.

In recent years, attempts have been made to manufacture a resin pellet that includes a microcapsule encompassing a heat storage material. JP2019-137723A specifically discloses a pellet that includes a microcapsule encompassing a heat storage material and has a capsule wall composed of a melamine resin. In addition, JP2007-284517A discloses a granulated body obtained by using a microcapsule encompassing a heat storage material and using a polyvinyl alcohol.

### SUMMARY OF THE INVENTION

By the way, it is desired that a tensile breaking strength of a molded product obtained by using a microcapsule encompassing a heat storage material and using a resin pellet containing a resin is about the same as a tensile breaking strength of the resin contained in the resin pellet. In other words, it is desired to provide a resin pellet that enables the molding of a molded product exhibiting a tensile breaking strength at the same level as that of a tensile breaking strength of a molded product that is formed from a resin contained in the resin pellet and does not include microcapsules encompassing a heat storage material.

As a result of evaluating the above-described characteristics by using the pellets described in JP2019-137723A and the granulated body described in JP2007-284517A, the inventors of the present invention found that the above requirements are not sufficiently satisfied.

In consideration of the above circumstances, an object of the present invention is to provide a resin pellet that enables the molding of a molded product exhibiting a tensile breaking strength at the same level as that of a tensile breaking strength of a resin contained in the resin pellet.

In addition, another object of the present invention is to provide a manufacturing method for a resin pellet, a molded product, an automobile part, an electronic apparatus part, and a fiber.

As a result of carrying out intensive studies to achieve the above-described object, the inventors of the present invention have found that the above-described object can be achieved by the following configurations.

(1) A resin pellet comprising:

a microcapsule encompassing a heat storage material; and

a thermoplastic resin,

in which a content of the heat storage material is 70% by mass or less with respect to a total mass of the resin pellet, and

a capsule wall of the microcapsule contains at least one resin selected from the group consisting of polyurethane urea, polyurethane, and polyurea.

(2) The resin pellet according to (1), in which the capsule wall of the microcapsule contains polyurethane urea.

(3) The resin pellet according to (1) or (2), in which a total content of the microcapsule and the thermoplastic resin is more than 90% by mass with respect to the total mass of the resin pellet.

(4) The resin pellet according to any one of (1) to (3), in which the resin contained in the capsule wall of the microcapsule has a structure represented by Formula (Y),

(5) The resin pellet according to any one of (1) to (4), in which the resin contained in the capsule wall of the microcapsule is a resin obtained by reacting

an aromatic or alicyclic diisocyanate,

a compound having three or more active hydrogen groups in one molecule, and

a polymethylenepolyphenyl polyisocyanate.

(6) The resin pellet according to (5), in which the compound having three or more active hydrogen groups in one molecule is a polyol having a molecular weight of 500 or less.

(7) The resin pellet according to any one of (1) to (6), in which the resin contained in the capsule wall of the microcapsule is formed from

a trifunctional or higher functional polyisocyanate A which is an adduct of an aromatic or alicyclic diisocyanate and a compound having three or more active hydrogen groups in one molecule, and

a polyisocyanate B selected from the group consisting of an aromatic diisocyanate and a polymethylenepolyphenyl polyisocyanate.

(8) The resin pellet according to any one of (1) to (7), in which a thermal decomposition temperature of the capsule wall of the microcapsule is 200° C. or higher.

(9) The resin pellet according to any one of (1) to (8), in which a thickness of the capsule wall of the microcapsule is 0.10 to 5.0 μm.

(10) The resin pellet according to any one of (1) to (9), in which an average inner diameter of the microcapsules is 200 μm or less.

(11) The resin pellet according to any one of (1) to (10), in which a melting point of the thermoplastic resin is 110° C. or higher.

(12) The resin pellet according to any one of (1) to (11), in which the thermoplastic resin is a water-insoluble resin.

(13) A manufacturing method for the resin pellet according to any one of (1) to (12), the manufacturing method comprising:

melting and kneading the thermoplastic resin in an extruder, adding the microcapsule to a melt of the thermoplastic resin in the extruder, followed by further melting and kneading, and cutting a strand extruded from the extruder to manufacture the resin pellet.

(14) A molded product that is formed of the resin pellet according to any one of (1) to (12).

(15) An automobile part that is formed of the resin pellet according to any one of (1) to (12).

(16) An electronic apparatus part that is formed of the resin pellet according to any one of (1) to (12).

(17) A fiber that is formed of the resin pellet according to any one of (1) to (12).

According to the present invention, it is possible to provide a resin pellet that enables the molding of a molded product exhibiting a tensile breaking strength at the same level as that of a tensile breaking strength of a resin contained in the resin pellet.

In addition, according to the present invention, it is also possible to provide a manufacturing method for a resin pellet, a molded product, an automobile part, an electronic apparatus part, and a fiber.

### BRIEF DESCRIPTION OF THE DRAWINGS

FIG. 1 is a partial schematic view of an SEM image of a cross section of a resin pellet.

### DESCRIPTION OF THE PREFERRED EMBODIMENTS

In the present specification, numerical ranges expressed using “to” include numerical values before and after the “to” as the lower limit value and the upper limit value.

In the numerical ranges disclosed stepwise in the present specification, an upper limit value or a lower limit value disclosed in a certain numerical range may be replaced with an upper limit value or a lower limit value disclosed in another numerical range disclosed in stepwise. In addition, in the numerical ranges disclosed in the specification, an upper limit value or a lower limit value disclosed in a certain numerical range may be replaced with values shown in examples.

One kind of various components described below may be used alone, or two or more kinds thereof may be mixedly used. For example, one kind of polyisocyanate described below may be used alone, or two or more kinds thereof may be mixedly used.

A feature point of the resin pellet according to the embodiment of the present invention is that the capsule wall of the microcapsule contains a predetermined resin and the content of the heat storage material is equal to or smaller than a predetermined value.

It has been found that a decrease in tensile breaking strength is suppressed by selecting a predetermined resin as a material of the capsule wall of the microcapsule. In addition, it has been found that in a case where the content of the heat storage material is too large, the tensile breaking strength of the obtained molded product decreases, and it has been found that in a case of setting the content thereof to a predetermined value or less, the decrease in the tensile breaking strength is suppressed.

The resin pellet according to the embodiment of the present invention contains microcapsules (hereinafter, also simply referred to as “microcapsules”) encompassing a heat storage material and a thermoplastic resin.

Hereinafter, first, components contained in the resin pellet will be described in detail.

<Microcapsule>

The microcapsule has a core part and a capsule wall for encompassing a core material (an encompassed material (also referred to as an encompassed component)) that forms the core part.

The microcapsule encompasses a heat storage material as the core material (the encompassed component). Since the heat storage material is encompassed in the microcapsule, the heat storage material can be stably present in a phase state that depends on the temperature.

(Heat Storage Material)

The kind of the heat storage material is not particularly limited. A material of which the phase changes in response to a temperature change can be used, and it is preferably a material in which a phase change between a solid phase and a liquid phase, accompanied by a state change of melting and solidification in response to a temperature change, is repeated.

The phase change of the heat storage material is preferably based on the phase change temperature of the heat storage material itself, and in a case of a phase change between a solid phase and a liquid phase, it is preferably based on the melting point.

The heat storage material may be, for example, any one of a material that can store, as sensible heat, heat generated outside a molded product manufactured by using the resin pellet, a material that can store, as latent heat, heat generated outside a molded product manufactured by using the resin pellet (hereinafter, also referred to as a “latent heat storage material”), or a material that undergoes a phase change accompanied by a reversible chemical change. It is preferable that the heat storage material is capable of releasing the stored heat.

Among the above, the heat storage material is preferably a latent heat storage material in terms of ease of control of the heat quantity that can be transferred and received and the size of the heat quantity.

The latent heat storage material is a material that carries out heat storage of heat generated outside a molded product manufactured by using the resin pellet, as the latent heat. For example, in a case of a phase change between a solid phase and a liquid phase, it refers to a material that can carry out the transfer and reception of heat with the latent heat, by repeating a change between melting and solidification with a melting point determined depending on the material using as a phase change temperature.

In a case of a phase change between a solid phase and a liquid phase, the latent heat storage material can utilize the heat of fusion at the melting point and the heat of solidification at the freezing point, thereby storing heat or dissipating heat in response to the phase change between the solid and the liquid.

The kind of the latent heat storage material is not particularly limited and can be selected from compounds having a melting point and capable of undergoing a phase change.

Examples of the latent heat storage material include ice (water); inorganic salts; aliphatic hydrocarbons such as paraffin (for example, isoparaffin and normal paraffin); fatty acid ester-based compounds such as tri(capryl/capric acid) glyceryl, methyl myristate (melting point: 16° C. to 19° C.), isopropyl myristate (melting point: 167° C.), and dibutyl phthalate (melting point: −35° C.); aromatic hydrocarbons such as an alkyl naphthalene compound such as diisopropyl naphthalene (melting point: 67° C. to 70° C.), a diaryl alkane-based compound such as 1-phenyl-1-xylyl ethane (melting point: less than −50° C.), an alkyl biphenyl-based compound such as 4-isopropyl biphenyl (melting point: 11° C.), a triaryl methane-based compound, an alkylbenzene-based compound, a benzyl naphthalene-based compound, a diaryl alkylene-based compound, and an aryl indane-based compound; natural animal and vegetable oils such as camellia oil, soybean oil, corn oil, cotton seed oil, rape seed oil, olive oil, palm oil, castor oil, and fish oil; mineral oils; diethyl ethers; aliphatic diols; sugars; and sugar alcohols.

The phase change temperature of the heat storage material is not particularly limited and may be appropriately selected depending on the kind of the heating element that generates heat, the heat generation temperature of the heating element, the temperature or holding temperature after cooling, the cooling method, and the like.

As the heat storage material, it is preferable to select a material having a phase change temperature (preferably a melting point) in a target temperature range (for example, an operation temperature of a heating element; hereinafter, also referred to as a “heat control range”).

The phase change temperature of the heat storage material varies depending on the heat control range; however, it is preferably 0° C. to 80° C. and more preferably 10° C. to 70° C.

From the viewpoint that the heat storage property of the molded product manufactured by using the resin pellet is more excellent, the latent heat storage material is preferably an aliphatic hydrocarbon and more preferably paraffin.

The melting point of the aliphatic hydrocarbon (preferably paraffin) is not particularly limited; however, it is preferably 0° C. or higher, more preferably 15° C. or higher, and still more preferably 20° C. or higher in terms of the application to various use applications. The upper limit thereof is not particularly limited; however, it is preferably 80° C. or lower, more preferably 70° C. or lower, still more preferably 60° C. or lower, and particularly preferably 50° C. or lower.

From the viewpoint that the heat storage property of the molded product manufactured by using the resin pellet is more excellent, the aliphatic hydrocarbon is preferably a linear aliphatic hydrocarbon. The number of carbon atoms of the linear aliphatic hydrocarbon is not particularly limited; however, the linear aliphatic hydrocarbon preferably has 14 or more carbon atoms, more preferably 16 or more carbon atoms, and still more preferably 17 or more carbon atoms. The upper limit thereof is not particularly limited; however, it is preferably 30 or less, more preferably 28 or less, and still more preferably 26 or less.

The aliphatic hydrocarbon is preferably a linear aliphatic hydrocarbon having a melting point of 0° C. or higher, and it is more preferably a linear aliphatic hydrocarbon having a melting point of 0° C. or higher and having 14 or more carbon atoms.

Examples of the linear aliphatic hydrocarbon (linear paraffin) having a melting point of 0° C. or higher include n-tetradecane (melting point: 6° C.), n-pentadecane (melting point: 10° C.), n-hexadecane (melting point: 18° C.), n-heptadecane (melting point: 22° C.), n-octadecane (melting point: 28° C.), n-nonadecane (melting point: 32° C.), n-eicosane (melting point: 37° C.), n-henicosane (melting point: 40° C.), n-docosane (melting point: 44° C.), n-tricosane (melting point: 48° C. to 50° C.), n-tetracosane (melting point: 52° C.), n-pentacosane (melting point: 53° C. to 56° C.), n-hexacosane (melting point: 57° C.), n-heptacosane (melting point: 60° C.), n-octacosane (melting point: 62° C.), n-nonacosane (melting point: 63° C. to 66° C.), and n-triacontane (melting point: 66° C.).

In a case where a linear aliphatic hydrocarbon is used as the heat storage material, the content of the linear aliphatic hydrocarbon is preferably 80% by mass or more, more preferably 90% by mass or more, still more preferably 95% by mass or more, and particularly preferably 98% by mass or more, with respect to the content of the heat storage material. The upper limit thereof is, for example, 100% by mass.

The inorganic salt is preferably an inorganic hydrated salt, and examples thereof include a hydrate of a chloride of an alkali metal (for example, sodium chloride dihydrate or the like) a hydrate of an acetate of an alkali metal (for example, sodium acetate water), a hydrate of a sulfate of an alkali metal (for example, a sodium sulfate hydrate), a hydrate of a thiosulfate of an alkali metal (for example, a sodium thiosulfate hydrate), a hydrate of a sulfate of an alkaline earth metal (for example, a calcium sulfate hydrate), and a hydrate of a chloride of an alkaline earth metal (for example, a calcium chloride hydrate).

Examples of the aliphatic diol include 1,6-hexanediol and 1,8-octanediol.

Examples of the sugar and the sugar alcohol include xylitol, erythritol, galactitol, and dihydroxyacetone.

One kind of heat storage material may be used alone, or two or more kinds thereof may be mixedly used. In a case of using one kind of heat storage material alone, or a plurality kinds thereof having melting points different from each other, it is possible to adjust the temperature range in which the heat storage property is exhibited and the stored heat quantity according to the use application.

Focusing on a heat storage material having a melting point at a center temperature at which a heat storage action of a heat storage material is desired to be obtained, in a case of mixing a heat storage material having melting point smaller or larger than the center temperature, it is possible to expand the temperature range in which the heat storage is possible. As an example, a case where paraffin is used as the heat storage material is specifically described as follows; in a case where a paraffin a having a melting point at a center temperature at which a heat storage action of a heat storage material is desired to be obtained is used as a center material, and the paraffin a is mixed with another paraffin, the number of carbon atoms of which is smaller or larger than that of the paraffin a, a molded product manufactured using the resin pellet can be designed to have a wide temperature range (a heat control range).

The content of the paraffin having a melting point at a center temperature at which a heat storage action is desired to be obtained is not particularly limited; however, is preferably 80% by mass or more, more preferably 90% by mass or more, still more preferably 95% by mass or more, and particularly preferably 98% by mass or more, with respect to the total mass of the heat storage material. The upper limit thereof is, for example, 100% by mass.

In a case where paraffin is used as the heat storage material, one kind of paraffin may be used alone, or two or more kinds thereof may be mixedly used. In a case where a plurality of paraffins having melting points different from each other are used, it is possible to expand a temperature range in which the heat storage property is exhibited.

In a case where a plurality of paraffins are used, the content of the main paraffin is not particularly limited in terms of the temperature range in which the heat storage property is exhibited and the stored heat quantity; however, it is preferably 80% to 100% by mass, more preferably 90% to 100% by mass, and still more preferably 95% to 100% by mass, with respect to the total mass of the paraffin.

It is noted that the “main paraffin” refers to the paraffin having the highest content among the plurality of contained paraffins. The content of the main paraffin is preferably 50% by mass or more with respect to the total mass of the paraffin.

The content of the paraffin is not particularly limited; however, it is preferably 80 to 100% by mass, more preferably 90% to 100% by mass, still more preferably 95% to 100% by mass, and particularly preferably 98% to 100% by mass, with respect to the total mass of the heat storage material (preferably the latent heat storage material).

In addition, the paraffin is preferably a linear paraffin, it is preferable that a branched paraffin is substantially not included. This is because the heat storage property is further improved in a case where a linear paraffin is included and a branched paraffin is substantially not included. This is presumed to be due to that the association of linear paraffin molecules with each other can be suppressed by the inhibition by the branched paraffin.

The content of the heat storage material in the resin pellets is 70% by mass or less with respect to the total mass of the resin pellet.

Among the above, from the viewpoint that the tensile breaking strength of the molded product obtained by using the resin pellet according to the embodiment of the present invention is more excellent (hereinafter, also simply referred to as “the viewpoint that the effect of the present invention is more excellent”), it is preferably 50% by mass or less and more preferably 40% by mass or less. The lower limit thereof is not particularly limited; however, it is preferably 10% by mass or more and more preferably 20% by mass or more from the viewpoint the heat storage property of the molded product is more excellent.

The content of the heat storage material in the microcapsule is not particularly limited; however, it is preferably 40% to 95% by mass and more preferably 60% to 85% by mass in terms of the heat storage property and the heat resistance of the microcapsule.

(Other Components)

The core material of the microcapsule may encompass components other than the above-described heat storage material. Examples of other components that can be encompassed in the microcapsule as the core material include additives such as a solvent, an ultraviolet absorbing agent, a light stabilizer, an antioxidant, a wax, an odor suppressant, and a flame retardant.

The content of the heat storage material in the core material is not particularly limited. However, it is preferably 80% to 100% by mass and more preferably 90% to 100% by mass with respect to the total mass of the core material from the viewpoint that the heat storage property of the molded product manufactured by using the resin pellet is more excellent.

The microcapsule may encompass a solvent as a core material.

Examples of the solvent in this case include the above-described heat storage material of which the melting point is out of a temperature range (a heat control range; for example, an operation temperature of a heating element) in which a molded product manufactured by using the resin pellets is used. That is, the solvent refers to a solvent that does not undergo a phase change in a liquid state in the heat control range, and it is distinguished from a heat storage material in which a phase transition occurs in the heat control range and a heat absorption or dissipation reaction occurs.

The content of the solvent in the core material is not particularly limited; however, it is preferably less than 30% by mass, more preferably less than 10% by mass, and still more preferably 1% by mass or less with respect to the total mass of the core material. The lower limit thereof is not particularly limited; however, 0% by mass can be mentioned.

(Capsule Wall (Wall Part))

The microcapsule has a capsule wall encompassing a core material.

Examples of the material that forms the capsule wall in the microcapsule include at least one resin selected from the group consisting of polyurethane urea, polyurethane, and polyurea. Among them, polyurethane urea is preferable from the viewpoint that the effect of the present invention is more excellent.

It is noted that the polyurethane is a polymer having a plurality of urethane bonds, where it is preferably a reaction product of a polyol and a polyisocyanate.

In addition, the polyurea is a polymer having a plurality of urea bonds, where it is preferably a reaction product of a polyamine and a polyisocyanate.

Further, the polyurethane urea is a polymer having a urethane bond and a urea bond, where it is preferably a reaction product of a polyol, a polyamine, and a polyisocyanate, or a reaction product of a polyol and a polyisocyanate.

It is noted that in a case where a polyol and a polyisocyanate are reacted to obtain polyurethane urea, a part of the polyisocyanate reacts with water to form a polyamine, whereby polyurethane urea is obtained.

The capsule wall of the microcapsule preferably has a urethane bond. The capsule wall having a urethane bond can be obtained by using, for example, the above-described polyurethane urea or polyurethane.

Since the urethane bond is a bond having high mobility, it is possible to provide thermoplasticity to the capsule wall. In addition, the flexibility of the capsule wall can be easily adjusted. As a result, it is difficult to impair the resin characteristics of the resin pellet, and it is easy to suppress a decrease in tensile breaking strength.

The polyurethane, the polyurea, and the polyurethane urea are preferably formed from a polyisocyanate.

The polyisocyanate is a compound having two or more isocyanate groups, and examples thereof include an aromatic polyisocyanate and an aliphatic polyisocyanate.

Examples of the aromatic polyisocyanate include m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxy-biphenyldiisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, and 4,4′-diphenylhexafluoropropane diisocyanate.

Examples of the aliphatic polyisocyanate include trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatemethyl)cyclohexane, 1,3-bis(isocyanatemethyl)cyclohexane, isophorone diisocyanate, lysine diisocyanate, and a hydrogenated xylylene diisocyanate.

It is noted that although the difunctional aromatic polyisocyanate and the aliphatic polyisocyanate have been exemplified in the above description, examples of the polyisocyanate also include a trifunctional or higher functional polyisocyanates (for example, a trifunctional triisocyanate or a tetrafunctional tetraisocyanate).

More specific examples of the polyisocyanate also include a burette which is a trimer of the above-described difunctional polyisocyanate or an isocyanurate, an adduct of a polyol such as trimethylolpropane and a difunctional polyisocyanate, a formalin condensate of benzene isocyanate, a polyisocyanate having a polymerizable group such as methacryloyloxyethyl isocyanate, and a lysine triisocyanate.

The polyisocyanate is described in “Polyurethane Resin Handbook” (edited by Keiji Iwata, published by NIKKAN KOGYO SHIMBUN, LTD., (1987)).

Among them, the polyisocyanate is preferably a trifunctional or higher functional polyisocyanate.

Examples of the trifunctional or higher functional polyisocyanate include a trifunctional or higher functional aromatic polyisocyanate and a trifunctional or higher functional aliphatic polyisocyanate.

The trifunctional or higher functional polyisocyanate is also preferably a trifunctional or higher functional polyisocyanate (a trifunctional or higher functional polyisocyanate which belongs to an adduct type) which is an adduct of a difunctional polyisocyanate and a compound (for example, a polyol, polyamine, or polythiol which is trifunctional or higher functional) having three or more active hydrogen groups in one molecule, or a trimer of a difunctional polyisocyanate (biuret type or isocyanurate type).

Examples of the trifunctional or higher functional polyisocyanate which belong to an adduct type include TAKENATE (registered trade name) D-102, D-103, D-103H, D-103M2, P49-75S, D-110N, D-120N, D-140N, D-160N (all, manufactured by Mitsui Chemicals, Inc.), Desmodur (registered trade name) L75, UL57SP (manufactured by Sumika Bayer Urethane Co., Ltd.), CORONATE (registered trade name) HL, HX, L (manufactured by Nippon Polyurethane Industry Co., Ltd.), P301-75E (manufactured by Asahi Kasei Corporation), and BURNOCK (registered trade name) D-750 (manufactured by DIC Corporation).

Among them, trifunctional or higher functional polyisocyanate which belongs to an adduct type is preferably TAKENATE (registered trade name) D-110N, D-120N, D-140N, D-160N, manufactured by Mitsui Chemicals, Inc., or BURNOCK (registered trade name) D-750, manufactured by DIC Corporation.

Examples of the trifunctional or higher functional polyisocyanate which belong to an isocyanurate type include TAKENATE (registered trade name) D-127N, D-170N, D-170HN, D-172N, D-177N, D-204, D-204EA-1, D-262, D-268, D-370N, D-376N (manufactured by Mitsui Chemicals, Inc.), Sumidur N3300, Desmodur (registered trade name) N3600, N3900, Z4470BA (manufactured by Sumika Bayer Urethane Co., Ltd.), CORONATE (registered trade name) HX, HK (manufactured by Nippon Polyurethane Industry Co., Ltd.), and DURANATE (registered trade name) TPA-100, TKA-100, TSA-100, TSS-100, TLA-100, TSE-100 (manufactured by Asahi Kasei Corporation).

Examples of the trifunctional or higher functional polyisocyanate which belong to a biuret type include TAKENATE (registered trade name) D-165N, NP1100 (manufactured by Mitsui Chemicals, Inc.), Desmodur (registered trade name) N3200 (manufactured by Sumika Bayer Urethane Co., Ltd.), and DURANATE (registered trade name) 24A-100 (manufactured by Asahi Kasei Corporation).

In addition, the polyisocyanate is preferably a polymethylenepolyphenyl polyisocyanate.

The polymethylenepolyphenyl polyisocyanate is preferably a compound represented by Formula (X).

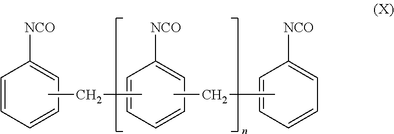

In Formula (X), n represents the number of repeating units. The number of repeating units represents an integer of 1 or more, and from the viewpoint that the effect of the present invention is more excellent, n is preferably an integer of 1 to 10 and more preferably an integer of 1 to 5.

Examples of the polyisocyanate containing a polymethylenepolyphenyl polyisocyanate include Millionate MR-100, Millionate MR-200, and Millionate MR-400 (manufactured by Tosoh Corporation), WANNATE PM-200 and WANNATE PM-400 (manufactured by Wanhua Chemical Group Co., Ltd.), COSMONATE M-50, COSMONATE M-100, COSMONATE M-200, and COSMONATE M-300 (manufactured by Mitsui Chemicals, Inc.), and Boranate M-595 (manufactured by Dow Chemical Company).

The polyol is a compound having two or more hydroxyl groups, and examples thereof include a low-molecular-weight polyol (for example, an aliphatic polyol or an aromatic polyol), a polyether-based polyol, a polyester-based polyol, a polylactone-based polyol, and a castor oil-based polyol, a polyolefin-based polyol, and a hydroxyl group-containing amine-based compound.

The low-molecular-weight polyol means a polyol having a molecular weight of 500 or less, and examples thereof include difunctional low-molecular-weight polyols such as ethylene glycol, diethylene glycol, or propylene glycol, and trifunctional or higher functional low-molecular-weight polyols such as glycerin, trimethylolpropane, hexanetriol, and pentaerythritol, and sorbitol.

From the viewpoint of controlling the flexibility of the microcapsule and further suppressing a decrease in tensile breaking strength and the viewpoint of improving the heat resistance, the polyol is preferably a low-molecular-weight polyol, more preferably a trifunctional or higher functional low-molecular-weight polyol, and still more preferably a trifunctional low-molecular-weight polyol.

Examples of the hydroxyl group-containing amine-based compound include an amino alcohol as an oxyalkylated derivative of an amino compound. Examples of the amino alcohol include N,N,N′,N′-tetrakis[2-hydroxypropyl]ethylenediamine, which is a propylene oxide or ethylene oxide adduct of an amino compound such as ethylenediamine, and N,N,N′,N′-tetrakis[2-hydroxyethyl]ethylenediamine.

The polyamine is a compound having two or more amino groups (a primary amino group and a secondary amino group), and examples thereof include an aliphatic polyvalent amine such as diethylenetriamine, triethylenetetramine, 1,3-propylenediamine, tetraethylenepentamine, or hexamethylenediamine; an epoxy compound adduct of an aliphatic polyvalent amine; an alicyclic polyvalent amine such as piperazine; and a heterocyclic diamine such as 3,9-bis-aminopropyl-2,4,8,10-tetraoxaspiro-(5,5)undecane.

From the viewpoint of improving the heat resistance of the resin, the polyamine is preferably a low-molecular-weight polyamine, more preferably a trifunctional or higher functional low-molecular-weight polyamine, and still more preferably a trifunctional or tetrafunctional low-molecular-weight polyamine.

The low-molecular-weight polyamine means a polyamine having a molecular weight of 500 or less.

Among the above, the resin contained in the capsule wall preferably has a structure represented by Formula (Y) from the viewpoint that the bleeding of the heat storage material is small even in a case where the molded product molded using the resin pellet is exposed to a high temperature environment.

The structure represented by Formula (Y) corresponds to a structure included in a resin to be obtained in a case where the compound represented by Formula (X) described above is used as a raw material of the polyisocyanate.

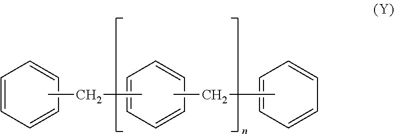

In Formula (Y), n represents the number of repeating units. The number of repeating units represents an integer of 1 or more, and from the viewpoint that the effect of the present invention is more excellent, n is preferably an integer of 1 to 10 and more preferably an integer of 1 to 5.

Among the above, the resin contained in the capsule wall is preferably a resin obtained by reacting an aromatic or alicyclic diisocyanate, a compound having three or more active hydrogen groups in one molecule, and a polymethylenepolyphenyl polyisocyanate, from the viewpoint that the bleeding of the heat storage material is small even in a case where the molded product molded using the resin pellet is exposed to a high temperature environment.

The aromatic or aliphatic diisocyanate is preferably an aromatic diisocyanate from the viewpoint of heat resistance. In addition, the compound having three or more active hydrogen groups in one molecule is preferably a polyol and more preferably a low-molecular-weight polyol.

In particular, the resin contained in the capsule wall is preferably formed from a trifunctional or higher functional polyisocyanate A (hereinafter, simply also referred to as a “polyisocyanate A”) which is an adduct of an aromatic or alicyclic diisocyanate and a compound having three or more active hydrogen groups in one molecule, and a polyisocyanate B (hereinafter, simply also referred to as a “polyisocyanate B”) selected from the group consisting of an aromatic diisocyanate and a polymethylenepolyphenyl polyisocyanate.

That is, the capsule wall is preferably a capsule wall containing the above resin (at least one resin selected from the group consisting of polyurea, polyurethane urea, and polyurethane) formed from the polyisocyanate A and the polyisocyanate B.

In a case of using the polyisocyanate A and the polyisocyanate B, the effect of the present invention is more excellent. In addition, in a case of using the polyisocyanate A and the polyisocyanate B, the disruption of the microcapsule is suppressed under high temperature conditions.

It is noted that in a case where an adduct of a polyol and a polyisocyanate is used as the polyisocyanate A and reacted with the polyisocyanate B, polyurethane urea may be often obtained as a result the reaction, similar to the case of the reaction product of the polyol and the polyisocyanate.

It is noted that as the polyisocyanate B, an aromatic diisocyanate may be used alone, a polymethylenepolyphenyl polyisocyanate may be used alone, or both of them may be mixedly used. Among the above, the polyisocyanate B is preferably a mixture of an aromatic diisocyanate and a polymethylenepolyphenyl polyisocyanate.

In the mixture, the mass ratio of the polymethylenepolyphenyl polyisocyanate to the aromatic diisocyanate (the mass of the polymethylenepolyphenyl polyisocyanate/the mass of the aromatic diisocyanate) is not particularly limited; however, it is preferably 0.1 to 10, more preferably 0.5 to 2, and still more preferably 0.75 to 1.5.

The viscosity of the polyisocyanate B is not particularly limited; however, it is preferably 100 to 1,000 mPa·s from the viewpoint that the effect of the present invention is more excellent.

It is noted that the viscosity is a viscosity at 25° C.

In a case where the polyisocyanate A and the polyisocyanate B are used in combination, the mass ratio of the polyisocyanate A to the polyisocyanate B (the mass of the polyisocyanate A/the mass of the polyisocyanate B) is not particularly limited; however, it is preferably 98/2 to 20/80, more preferably 90/10 to 30/70, and still more preferably 85/15 to 40/60.

In a case where the mass ratio is within the above range, the effect of the present invention is more excellent.

The mass of the capsule wall in the microcapsule is not particularly limited; however, it is preferably 5% to 60% by mass and more preferably 15% to 40% by mass with respect to the total mass of the microcapsule.

(Physical Properties of Microcapsule)

The average particle diameter of the microcapsules is not particularly limited; however, it is preferably 1 to 500 μm, more preferably 1 to 200 μm, still more preferably 1 to 100 μm, and particularly preferably 2 to 50 μm. In a case where the particle diameter of the microcapsule is small, the appearance of the molded product is good.

The average inner diameter of the microcapsules is not particularly limited, and it is preferably 200 μm or less, more preferably 1 to 100 μm, and still more preferably 2 to 50 μm, from the viewpoint that the effect of the present invention is more excellent. The inner diameter of the microcapsule represents the diameter of the core part.

The average particle diameter and the average inner diameter of the microcapsules can be controlled by changing dispersion conditions in an emulsification step of a method described for a manufacturing method for a microcapsule, which will be described later.

The average particle diameter and the average inner diameter of the microcapsules are measured by the following methods.

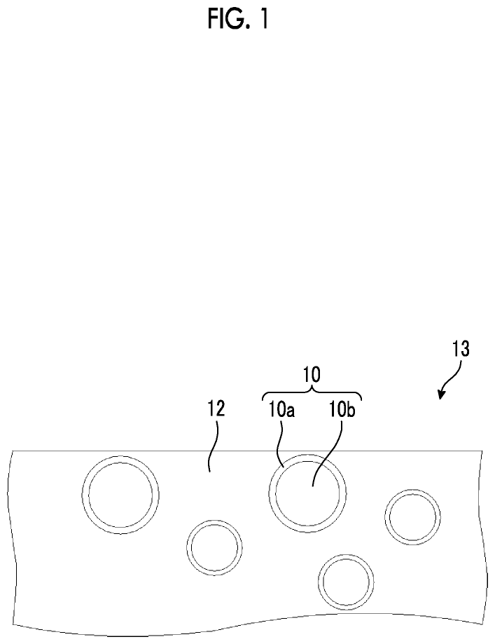

First, a cross-sectional slice of a molded product or resin pellet manufactured using the resin pellet is produced, and the cross-section thereof is observed with a scanning electron microscope (SEM) at a magnification of 1,000 times. FIG. 1 is a partial schematic view illustrating an SEM image of a cross section of a resin pellet 13. From the SEM image of the cross section, the inside of a microcapsule 10 (an encompassed material 10b), a capsule wall 10a, and a thermoplastic resin 12 are observed distinguishably. The particle diameter and the inner diameter of twenty microcapsules are measured in descending order from the largest microcapsule 10 among the microcapsules 10 present in the observed visual field and arithmetically averaged respectively to determine average values. This operation is carried out in five visual fields to determine the average of the average values obtained at each location, and the obtained values are respectively used as the average particle diameter and the average inner diameter of the microcapsules. It is noted that the inner diameter measured as described above is the longest inner diameter in a case where the microcapsule is observed.

The thickness (the wall thickness) of the capsule wall of the microcapsule is not particularly limited; however, it is preferably 10.00 μm or less, more preferably 5.00 μm or less, and still more preferably 2.00 μm or less from the viewpoint that the effect of the present invention is more excellent. On the other hand, since the hardness of the capsule wall can be maintained in a where the capsule wall has a certain level of thickness, the wall thickness is preferably 0.01 μm or more, and it is more preferably 0.10 μm or more and still more preferably 0.2 μm or more from the viewpoint that the bleeding of the heat storage material is small even in a case where the molded product molded using the resin pellet is exposed to a high temperature environment.

The wall thickness refers to an average value obtained by determining individual wall thicknesses (μm) of any twenty microcapsules with a scanning electron microscope (SEM) and averaging them.

Specifically, a cross-sectional slice of a molded product or resin pellet manufactured using the resin pellet is produced, the cross-section thereof is observed using SEM, and twenty microcapsules are selected among the microcapsules having a size of “average particle diameter ±10%”, where the average particle diameter is calculated by the above-described measuring method. The cross sections of the individual selected microcapsules are observed to measure the wall thicknesses, and the average value for the twenty microcapsules is calculated to determine the wall thicknesses of the microcapsules.

In a case where the average particle diameter of the above-described microcapsules is denoted as Dm [unit: μm] and the thickness of the capsule wall of the above-described microcapsule is denoted as δ [unit: μm], the ratio (δ/Dm) of the thickness of the capsule wall of the microcapsule to the average particle diameter of the microcapsules is preferably 0.300 or less, more preferably 0.200 or less, and still more preferably 0.100 or less.

The lower limit value of δ/Dm is preferably 0.001 or more, more preferably 0.005 or more, and still more preferably 0.010 or more, from the viewpoint that the hardness of the microcapsule can be maintained.

The glass transition temperature of the capsule wall of the microcapsule is not particularly limited; however, it is preferable that the glass transition temperature thereof is 150° C. or higher, or the capsule wall does not exhibit a glass transition temperature. That is, it is preferable that the glass transition temperature of the material constituting the capsule wall of the microcapsule is 150° C. or higher, or the material constituting the capsule wall of the microcapsule does not exhibit a glass transition temperature.

In a case where the capsule wall of the microcapsule exhibits a glass transition temperature, the glass transition temperature is preferably 160° C. or higher, more preferably 180° C. or higher, and still more preferably 200° C. or higher, from the viewpoint that the heat resistance is more excellent. In a case where the capsule wall of the microcapsule exhibits a glass transition temperature, the upper limit of the glass transition temperature is not particularly limited; however, the glass transition temperature is often equal to or lower than the thermal decomposition temperature of the capsule wall of the microcapsule, and it is generally 250° C. or lower.

Among the above, it is preferable that the capsule wall of the microcapsule does not exhibit a glass transition temperature from the viewpoint that the heat resistance is more excellent.

It is noted that the fact that the capsule wall of the microcapsule does not exhibit a glass transition temperature means that the capsule wall of the microcapsule (the material constituting the capsule wall of the microcapsule) does not exhibit a glass transition temperature in a case of being at a temperature from 25° C. to a temperature (the thermal decomposition temperature −5° C.) obtained by subtracting 5° C. from the thermal decomposition temperature of the capsule wall, which will be described below. That is, it means that the glass transition temperature is not exhibited in a range of “25° C.” to “(thermal decomposition temperature (° C.)-5° C.)”.

A method of adjusting the glass transition temperature of the capsule wall of the microcapsule to be 150° C. or higher or causing the capsule wall not to exhibit a glass transition temperature is not particularly limited, where this adjustment can be carried out by appropriately selecting a raw material used when manufacturing the microcapsule. Examples thereof include a method of constituting the capsule wall with polyurea since polyurea has the property of exhibiting a high glass transition temperature. In addition, a method of increasing the crosslink density in a material constituting the capsule wall is also included. Further, a method of introducing an aromatic ring group (for example, a benzene ring group) into a material constituting the capsule wall is also included.

Examples of the method of measuring the glass transition temperature of the capsule wall of the microcapsule include the following method.

Ethyl acetate is placed in a microcapsule, stirring is carried out at 25° C. for 24 hours. Then, the obtained solution is filtered, and the obtained residue is subjected to vacuum drying at 60° C. for 48 hours to obtain a microcapsule encompassing nothing inside (hereinafter, also simply referred to as a “measurement material”). That is, a capsule wall material of the microcapsule, which is a measurement target for the glass transition temperature, is obtained.

Next, the thermal decomposition temperature of the obtained measurement material is measured using a thermal gravity-differential thermal analyzer TG-DTA (device name: DTG-60, Shimadzu Corporation). Regarding the thermal decomposition temperature, it is noted that in the thermal gravimetric analysis (TGA) of the atmospheric atmosphere, a temperature at the time when the mass of the measurement material is reduced by 5% by mass with respect to the mass of the measurement material before heating is defined as the thermal decomposition temperature (° C.) in a case where the temperature of the measurement material has been elevated from room temperature at a constant temperature elevation rate (10° C./min).

Next, the glass transition temperature of the measurement material is measured using a differential scanning calorimeter DSC (device name: DSC-60a Plus, Shimadzu Corporation) and using a closed pan, at a temperature elevation rate of 5° C./min in a range of 25° C. to (thermal decomposition temperature (° C.)-5° C.). As the glass transition temperature of the capsule wall of the microcapsule, the value at the time of the temperature elevation at the second cycle is used.

The thermal decomposition temperature of the capsule wall of the microcapsule is not particularly limited; however, it is preferably 200° C. or higher, more preferably 220° C. or higher, and still more preferably 230° C. or higher, from the viewpoint that the heat resistance is more excellent.

The thermal decomposition temperature of the capsule wall means a temperature at the time when the mass of the capsule wall is reduced by 5% by mass. The measuring method thereof includes the method using the thermal gravity-differential thermal analyzer TG-DTA (device name: DTG-60, Shimadzu Corporation), which is carried out in measuring the glass transition temperature described above.

The content of the microcapsule in the resin pellet is not particularly limited, and it is adjusted such that the content of the heat storage material is adjusted to be within the above-described range. More specifically, from the viewpoint that the effect of the present invention is more excellent and the viewpoint that the heat storage property of the resin pellet is more excellent, the content of the microcapsule is preferably 10% to 85% by mass, more preferably 20% to 80% by mass, still more preferably 25% to 75% by mass, and particularly preferably 35% to 65% by mass, with respect to the total mass of the resin pellet. A large amount of the microcapsule in the resin pellet gives an excellent stored heat quantity, and the smaller the amount of the microcapsule is, the more excellent the tensile breaking strength of the molded product obtained by using the resin pellet is.

(Manufacturing Method for Microcapsule)

A manufacturing method for a microcapsule is not particularly limited, and a known method can be employed.

Examples thereof include an interfacial polymerization method including a step (an emulsification step) of dispersing an oil phase containing a heat storage material and a capsule wall material in a water phase containing an emulsifying agent to prepare an emulsified liquid and a step (an encapsulation step) of polymerizing the capsule wall material at the interface between the oil phase and the water phase to form a capsule wall, thereby forming a microcapsule.

The capsule wall material means a material on which a capsule wall can be formed.

Hereinafter, each of the steps of the interfacial polymerization method will be described in detail.

In the emulsification step of the interfacial polymerization method, an oil phase containing a heat storage material and a capsule wall material is dispersed in a water phase containing an emulsifying agent to prepare an emulsified liquid. It is noted that the capsule wall material contains a polyisocyanate and at least one compound selected from the group consisting of a polyol and a polyamine.

The emulsified liquid is formed by dispersing an oil phase containing a heat storage material and a capsule wall material in a water phase containing an emulsifying agent.

The oil phase may contain at least a heat storage material and a capsule wall material, and it may further contain other components such as a solvent and/or an additive, as necessary. From the viewpoint of excellent dispersion stability, the solvent which may be contained in the oil phase is preferably a water-insoluble organic solvent and more preferably ethyl acetate, methyl ethyl ketone, or toluene.

The water phase can contain at least an aqueous medium and an emulsifying agent.

Examples of the aqueous medium include water and a mixed solvent of water and a water-soluble organic solvent, where water is preferable. The “water-soluble” means that the dissolved amount of the target substance in 100% by mass of water at 25° C. is 5% by mass or more.

The content of the aqueous medium is not particularly limited; however, it is preferably 20% to 80% by mass, more preferably 30% to 70% by mass, and still more preferably 40% to 60% by mass, with respect to the total mass of the emulsified liquid which is a mixture of the oil phase and the water phase.

Examples of the emulsifying agent include a dispersing agent, a surfactant, and a combination thereof.

As the dispersing agent, a known dispersant can be used, where polyvinyl alcohol is preferable.

Examples of the surfactant include a nonionic surfactant, an anionic surfactant, a cationic surfactant, and an amphoteric surfactant. One kind of surfactant may be used alone, or two or more kinds thereof may be mixedly used.

The content of the emulsifying agent is preferably more than 0% by mass and 20% by mass or less, more preferably 0.005% to 10% by mass, still more preferably 0.01% to 10% by mass, and particularly preferably 1% to 5% by mass with respect to the total mass of the emulsified liquid which is a mixture of the oil phase and the water phase.

The water phase may contain another component such as an ultraviolet absorbing agent, an antioxidant, and a preservative, as necessary.

The dispersion refers to dispersing an oil phase as oil droplets in a water phase (emulsification). The dispersion can be carried out using a commonly used device for dispersing an oil phase and a water phase (for example, a homogenizer, a Manton Gaulin homogenizer, an ultrasonic wave disperser, a dissolver, a keddy mill, or another known dispersion apparatus).

The mixing ratio of the oil phase to the water phase (the oil phase mass/the water phase mass) is preferably 0.1 to 1.5, more preferably 0.2 to 1.2, and still more preferably 0.4 to 1.0.

In the encapsulation step, the capsule wall material is polymerized at the interface between the oil phase and the water phase to form a capsule wall, thereby forming a microcapsule.

The polymerization is preferably carried out under heating. The reaction temperature in the polymerization is preferably 40° C. to 100° C. and more preferably 50° C. to 80° C. The polymerization reaction time is preferably about 0.5 to 10 hours and more preferably about 1 to 5 hours.

In order to prevent the aggregation of microcapsules during the polymerization, it is preferable to further add an aqueous solution (for example, water or an aqueous acetic acid solution) to reduce the collision probability between the microcapsules.

In addition, it is also preferable to carry out sufficient stirring.

Further, a dispersing agent for preventing aggregation may be added to the reaction system during the polymerization.

Further, as necessary, a charge adjusting agent such as nigrosine or any other auxiliary agent may be added to the reaction system during the polymerization.

<Thermoplastic Resin>

The resin contained in the resin pellet is not particularly limited, and examples thereof include a known thermoplastic resin.

Examples of the thermoplastic resin include an AS (acrylonitrile styrene) resin, an ABS (acrylonitrile butadiene styrene) resin, a polyethylene resin, a polyester resin (a polyether ester elastomer or the like), a polypropylene resin, an ethylene-propylene copolymer, polyvinylidene chloride, polyamide, an acetal resin, a polycarbonate resin, a polyphenylene sulfide resin, a polyether imide resin, an aromatic polyether ketone resin, a polysulfone resin, a fluororesin (polyvinylidene fluoride or the like), a polyamideimide resin, and an acrylic resin. Among them, a polypropylene resin, a polyethylene resin, an ABS (acrylonitrile butadiene styrene) resin, or a polyester resin is preferable.

The melting point of the thermoplastic resin is not particularly limited; however, it is preferably 110° C. or higher and more preferably 130° C. or higher from the viewpoint that the heat resistance of the molded product is more excellent. The upper limit thereof is not particularly limited; however, it is preferably 300° C. or lower and more preferably 250° C. or lower from the viewpoint that the moldability of the molded product is more excellent.

Examples of the measuring method for the melting point of the thermoplastic resin include a differential scanning calorimeter DSC.

From the viewpoint that the effect of the present invention is more excellent, the thermoplastic resin is preferably a water-insoluble resin.

The “water-insoluble” in the water-insoluble resin means that the dissolved amount of the target substance in 100% by mass of water at 25° C. is less than 5% by mass.

The content of the thermoplastic resin in the resin pellet is not particularly limited, and it is adjusted such that the content of the heat storage material is adjusted to be within the above-described range. More specifically, from the viewpoint that the effect of the present invention is more excellent and the viewpoint that the heat storage property of the resin pellet is more excellent, the content of the thermoplastic resin is preferably 15% to 85% by mass, more preferably 20% to 80% by mass, still more preferably 20% to 75% by mass, and particularly preferably 35% to 65% by mass, with respect to the total mass of the resin pellet. The larger the content of the thermoplastic resin in the resin pellet is, the more excellent the tensile breaking strength of the molded product obtained by using the resin pellet is, and the smaller the content thereof is, the more excellent stored heat quantity is obtained.

<Other Components>

The resin pellet may contain components other than the microcapsule and thermoplastic resin described above.

Examples of other components include a filler, a stabilizer, an oxidation or reduction agent, a molding aid, a decomposition inhibitor, a lubricant, a mold release agent, a coloring agent such as a pigment, a dispersing agent, and a plasticizer.

The filler is not particularly limited, and examples thereof include an inorganic filler composed of glass, silica, wollastonite, aluminum hydroxide, kaolin, titanium oxide, alumina, mica, talc, carbon, potassium titanate, and the like, and a metal filler composed of copper and the like. The shape of the filler may be a particle shape, a fiber shape, or whisker shape.

<Resin Pellet>

The resin pellet contains the microcapsule and the thermoplastic resin, described above.

The shape of the resin pellet is not particularly limited, and the size thereof is not particularly limited either.

The shape of the resin pellet is preferably cylindrical or prismatic, and more preferably cylindrical. For example, it is more preferable that the pellet has a cylindrical shape having a height of 0.01 to 100 mm (preferably 0.05 to 10 mm) and a diameter of 0.01 to 50 mm (preferably 0.05 to 30 mm).

It is preferable that the stored heat quantity of the resin pellet is high, and the stored heat quantity thereof is more preferably 40 J/g or more, more preferably 50 J/g or more, and still more preferably 70 J/g or more. The upper limit thereof is not particularly limited; however, it is often 300 J/g or less.

The stored heat quantity can be measured by differential scanning calorimetry (DSC) measurement.

It is preferable that the resin pellet exhibits a value of tensile breaking strength close to the value of the tensile breaking strength inherent in the thermoplastic resin, and a difference between the tensile breaking strength of the resin pellet and the tensile breaking strength of the thermoplastic resin contained in the resin pellet is preferably 0 MPa or more and 20 MPa or less, more preferably 0 MPa or more and less than 10 MPa, and still more preferably less than 0 MPa or more and less than 5 MPa.

<Manufacturing Method for Resin Pellet>

A manufacturing method for a resin pellet is not particularly limited, and examples thereof include a known method.

Examples thereof include a method of melting and kneading the microcapsule and the resin in an extruder and then cutting a strand extruded from the extruder to form a pellet.

The microcapsule is preferably handled as a powder. Examples of the method of obtaining the powder of the microcapsule include a method of removing a solvent from the dispersion liquid of the microcapsule obtained according to the above-described interfacial polymerization method to obtain the powder of the microcapsule. Examples of the method of removing a solvent include a method of obtaining a powder of the microcapsule from a dispersion liquid of the microcapsule using a spray dryer.

Among the above, a method of melting and kneading the thermoplastic resin in an extruder, adding the microcapsule to a melt of the thermoplastic resin in the extruder, followed by further melting and kneading, and cutting a strand extruded from the extruder to manufacture the resin pellet is preferable from the viewpoint that the disruption of the microcapsule during melting and kneading can be further suppressed.

Such a method as described above can be carried out by using an extruder equipped with a plurality of raw material supply ports. For example, a thermoplastic resin is supplied to an extruder equipped with a plurality of raw material supply ports to be melted and kneaded, the microcapsule is supplied to the extruder from a raw material supply port located downstream of the raw material supply port to which the thermoplastic resin has been supplied, to be further melted and kneaded, and a strand extruded from the extruder is cut, whereby a resin pellet can be manufactured.

The above method corresponds to a method in which the microcapsule is side-fed to an extruder to be mixed with a thermoplastic resin in a softened state. The side feed is a method in which a feeder that supplies the microcapsule is installed separately from a feeder that supplies the thermoplastic resin, and the feeder that supplies the microcapsule is charged with respect to the thermoplastic resin that has been kneaded in advance in the extruder.

A known device can be used as the extruder, and examples thereof include a known extruder (for example, a twin-screw extruder).

<Molded Product>

A molded product can be obtained by carrying out molding using the resin pellet according to the embodiment of the present invention.

The molded product contains microcapsules and a thermoplastic resin.

A molding method using the resin pellet is not particularly limited, and a known molding method can be used. Examples thereof include extrusion molding, injection molding, blow molding, compression molding, press molding, and molding with a 3D printer.

Examples of the molded product using the resin pellet according to the embodiment of the present invention include an automobile part, an electronic apparatus part, and a fiber (clothes).

Examples of the automobile part include an engine cover, a battery case, a heat exchanger, an interior part, and an intake system pipe of a vehicle.

Examples of the electronic apparatus part include a housing and a battery case.

### EXAMPLES

Hereinafter, the characteristics of the present invention will be described more specifically with reference to Examples and Comparative Examples. The materials, the amounts and proportions of the materials used, the details of treatments, the procedure of treatments, and the like shown in the following Examples can be appropriately modified as long as the gist of the present invention is maintained. Therefore, the scope of the present invention should not be construed to be limited by specific examples described below.

### Example 1

As a heat storage material, 100 parts by mass of eicosane (manufactured by Sasol Limited) was dissolved in 120 parts by mass of ethyl acetate to obtain a solution A. Further, 25 parts by mass of a trimethylolpropane adduct of tolylene diisocyanate (BURNOCK D-750, containing 25% ethyl acetate, manufactured by DIC Corporation) was added to the solution A under stirring to obtain a solution B. Then, 170 parts by mass of a 3% by mass aqueous solution of polyvinyl alcohol (Kuraray Poval KL-318, manufactured by Kuraray Co., Ltd.) was added to the solution B to carry out emulsification and dispersion. 300 parts by mass of water was added to the emulsified liquid after the emulsification and dispersion, the temperature was elevated to 70° C. with stirring, and stirring was carried out for 1 hour, followed by cooling. Further, water was added to the obtained solution to adjust the concentration, thereby obtaining a heat storage material-encompassing microcapsule solution having a solid content concentration of 20%.

The capsule wall of the microcapsule contained polyurethane urea.

The average particle diameter of the obtained microcapsules was 5 μm.

As shown in the following structural formula, BURNOCK D-750 described above corresponds to a trifunctional polyisocyanate which is an adduct of an aromatic diisocyanate and trimethylolpropane.

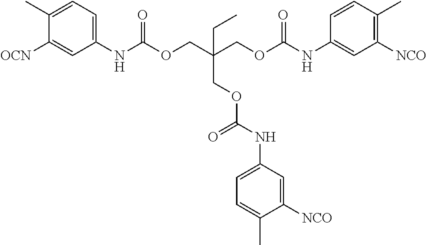

Next, the heat storage material-encompassing microcapsule solution prepared above was pulverized with a spray dryer (Mini Spray Dryer B-290, manufactured by BUCHI Labortechnik AG) to obtain a powder of the heat storage material-encompassing microcapsule.

Using a twin-screw extruder (2D25S) equipped with a first raw material supply port disposed on the upstream side and a second raw material supply port disposed on the downstream side, 100 parts by mass of a polypropylene resin (NOVATEC PP MA-3, manufactured by Japan Polypropylene Corporation) as a thermoplastic resin was charged into a twin-screw extruder from the first raw material supply port to melt the polypropylene resin under the condition of the melting temperature of 200° C. At that time, 100 parts by mass of the powder of the heat storage material-encompassing microcapsule was charged into the twin-screw extruder from the second raw material supply port, and the powder of the heat storage material-encompassing microcapsules was charged into the melt of the thermoplastic resin. The obtained melt in the twin-screw extruder was extruded from a die into a strand, and the strand was cut into a pellet to prepare a cylindrical resin pellet (diameter 3 mm×height 3 mm).

Using the above resin pellet, a plate material, which is a molded product having a length of 150 mm, a width of 50 mm, and a thickness of 1 mm, was produced by injection molding.

### Examples 2 to 25

Resin pellets and plate materials were manufactured according to the same procedure as in Example 1, except that the kinds and amounts of the polyisocyanate A, the polyisocyanate B, the heat storage material, and the resin, which would be used, and various characteristics of the microcapsules (the particle diameter, the wall thickness, 6/D, the glass transition temperature, and thermal decomposition temperature) were changed as shown in Table 1 described later.

It is noted that in Examples 2 to 25, the polyisocyanate A and the polyisocyanate B were used in a predetermined mass ratio instead of BURNOCK D-750 which was used in Example 1. The total mass of the polyisocyanate A and the polyisocyanate B is the same as the amount of the BURNOCK D750 which is used in Example 1.

### Comparative Example 1

A resin pellet was manufactured according to the procedure of Example 1 of JP2019-137723A. Using the manufactured resin pellet, a plate material was produced according to the same procedure as in Example 1.

It is noted that the capsule wall of the microcapsule used in Comparative Example 1 was composed of a melamine resin.

### Comparative Example 2

A resin pellet was manufactured according to the procedure of Example 6 of JP2019-218518A. Using the manufactured resin pellet, a plate material was produced according to the same procedure as in Example 1.

It is noted that in Comparative Example 2, a porous body (silica) was used as the heat storage material particle.

### Comparative Example 3

A resin pellet was manufactured according to the procedure of Example 10 of JP2007-284517A, except that the heat storage material used was changed to paraffin (eicosane). Using the manufactured resin pellet, a plate material was produced according to the same procedure as in Example 1.

It is noted that in Comparative Example 3, the content of the heat storage material was 74% by mass with respect to the total mass of the resin pellet.

In Table 1, “D-120N” indicates TAKENATE D-120N. As shown in the following structural formula, TAKENATE D-120N corresponds to a trifunctional polyisocyanate which is an adduct of an alicyclic diisocyanate and trimethylolpropane.

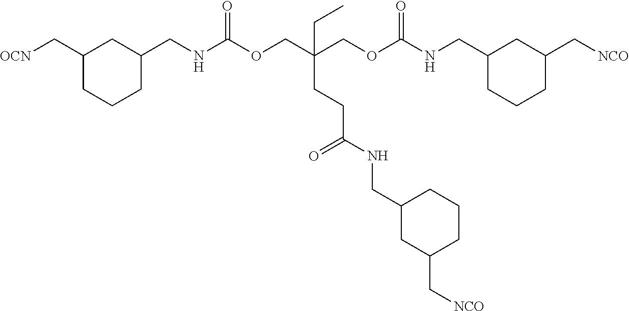

In Table 1, “MR-100” indicates Millionate MR-100, “MR-200” indicates Millionate MR-200, and “MR-400” indicates Millionate MR-400. All of Millionate MR-100, Millionate MR-200, and Millionate M-400 correspond to a mixture of diphenylmethane diisocyanate and a polymethylenepolyphenyl polyisocyanate (corresponding to a compound represented by Formula (X)).

In Table 1, the column of “Mass ratio (AB)” indicates the ratio of the mass of the polyisocyanate A to the mass of the polyisocyanate B.

In Table 1, the column of “Amount (with respect to capsule) [% by mass]” in the column of “Heat storage material” indicates the content (% by mass) of the heat storage material with respect to the total mass of the microcapsule.

In Table 1, the column of “Particle diameter (μm)” indicates the average particle diameter (μm) of the microcapsules.

In Table 1, the column of “Wall thickness” indicates the wall thickness of the capsule wall of the microcapsule.

In Table 1, the column of “Inner diameter (μm)” indicates the average inner diameter (μm) of the microcapsules.

In Table 1, the column of “δ/D” indicates the ratio of δ, which is the number average wall thickness (μm) of the microcapsules, to D, which is the average particle diameter (μm) of the microcapsules.

In Table 1, the column of “Thermal decomposition temperature [° C.]” indicates the thermal decomposition temperature (° C.) of the capsule wall of the microcapsule.

In Table 1, the column of “Kind” of the column of “Resin” indicates the kind of the thermoplastic resin.

In Table 1, in the column of “Resin”, the column of “Amount [% by mass]” indicates the content (% by mass) of the thermoplastic resin with respect to the total mass of the resin pellet.

In Table 1, the column of “Amount of heat storage material (with respect to resin pellet) [% by mass]” indicates the content (% by mass) of the heat storage material with respect to the total mass of the resin pellet.

In Table 1, “PP” in the “Resin” indicates NOVATEC PP MA-3 (manufactured by Japan Polypropylene Corporation, melting point: 170° C., a polypropylene resin), “PE” indicates NOVATEC HD HJ360 (melting point: 132° C., a polyethylene resin), “ABS” indicates TOYOLAC 600-309 (manufactured by Toray Industries, Inc., melting point: 130° C. to 150° C., an ABS resin), and “Elastomer” indicates Hytrel 3046 (manufactured by DuPont de Nemours, Inc., melting point: 160° C., a polyether ester resin), and “PVA” indicates polyvinyl alcohol.

It is noted that the polypropylene, the polyethylene, the ABS resin, and the polyether ester resin correspond to a water-insoluble resin.

<Evaluation>

(Stored Heat Quantity)

The resin pellets produced in Examples and Comparative Examples were subjected to the stored heat quantity measurement using a differential scanning calorimeter (DSC7020, manufactured by Hitachi High-Tech Science Corporation).

(Heat Resistance (Bleeding-Out))

After the plate materials produced in Examples and Comparative Examples were treated at 80° C. for 4 hours, whether or not bleeding (leakage) was observed was visually checked and evaluated according to the following criteria.

A: No bleeding was confirmed.

B: Slight bleeding was confirmed.

C: Bleeding was clearly confirmed.

(Tensile Breaking Strength)

Using the plate materials prepared in Examples and Comparative Examples, the tensile breaking strength of each plate material was measured according to JIS K7161.

In addition, using each resin used in each Example and Comparative Example, a comparative plate material, which is a molded product having a length of 150 mm, a width of 50 mm, and a thickness of 1 mm, was produced by injection molding. Using the comparative plate materials, the tensile breaking strength of each comparative plate material was measured according to JIS K7161.

The tensile breaking strengths of the plate materials produced in respective Examples and Comparative Examples were compared with the tensile breaking strengths of the comparative plate materials corresponding to respective Examples and Comparative Examples, and the difference therebetween was obtained and evaluated according to the following criteria.

A: Less than 5 MPa

B: 5 MPa or more and less than 10 MPa

C: 10 MPa or more

| | | | | | | | | | | | | | Physical | | | |
|---|---|---|---|---|---|---|---|---|---|---|---|---|---|---|---|---|
| | | | | | | | | | | | | | properties | | | |
| | | | | | | | | | | | | | Heat | | | |
| | | | | | | | | | | | | | storage | | | |
| | | | | | | | | | | | | | material | | | |
| | Capsule | | | | | | | | | | | | quanity | | | |
| | | | | Heat storage | | | | | | | | | (with | | | |
| | | | | material | | Physical properties | | | | | | | respect | Evaluation | | |
| | Wall material | | | | Amount | | | | | Thermal | | | to resin | Stored | | |
| | | | Mass | | (with respect | Particle | Wall | Inner | | decompositon | Resin | | pellet) | heat | Heat | Tensile |
| | Polyisocyanate | Polyisocyanate | ratio | | to capsule) | diameter | thickness | diameter | | temperature | | Amount | [% by | quantity | resistance | breaking |
| | A | B | A/B | Kind | [% by mass] | (μm) | (μm) | (μm) | [symbol] D | [° C.] | Kind | [% by mass] | mass] | ( [symbol] /g) | ( [symbol] ) | strength |
| Example 1 | D-750 | — | — | Paraffin | 60 | 5 | 0.38 | 4.24 | 0.076 | 212 | PP | 50 | 30 | 78 | C | A |
| | | | | (eicosane) | | | | | | | | | | | | |
| Example 2 | D-750 | MR-200 | 95/5 | Paraffin | 60 | 5 | 0.38 | 4.24 | 0.076 | 233 | PP | 50 | 30 | 80 | B | A |
| | | | | (eicosane) | | | | | | | | | | | | |
| Example 3 | D-750 | MR-200 | 85/15 | Paraffin | 60 | 5 | 0.38 | 4.24 | 0.076 | 238 | PP | 50 | 30 | 81 | A | A |
| | | | | (eicosane) | | | | | | | | | | | | |
| Example 4 | D-750 | MR-200 | 75/25 | Paraffin | 60 | 5 | 0.38 | 4.24 | 0.076 | 243 | PP | 50 | 30 | 82 | A | A |
| | | | | (eicosane) | | | | | | | | | | | | |
| Example 5 | D-750 | MR-200 | 50/50 | Paraffin | 60 | 5 | 0.38 | 4.24 | 0.076 | 249 | PP | 50 | 30 | 83 | A | A |
| | | | | (eicosane) | | | | | | | | | | | | |
| Example 6 | D-750 | MR-200 | 25/75 | Paraffin | 60 | 5 | 0.38 | 4.24 | 0.076 | 255 | PP | 50 | 30 | 85 | A | B |
| | | | | (eicosane) | | | | | | | | | | | | |
| Example 7 | D-120N | MR-200 | 75/25 | Paraffin | 60 | 5 | 0.38 | 4.24 | 0.076 | 221 | PP | 50 | 30 | 80 | B | A |
| | | | | (eicosane) | | | | | | | | | | | | |
| Example 8 | D-750 | MR-100 | 75/25 | Paraffin | 60 | 5 | 0.38 | 4.24 | 0.076 | 243 | PP | 50 | 30 | 83 | A | A |
| | | | | (eicosane) | | | | | | | | | | | | |
| Example 9 | D-750 | MR-400 | 75/25 | Paraffin | 60 | 5 | 0.38 | 4.24 | 0.076 | 243 | PP | 50 | 30 | 79 | A | A |
| | | | | (eicosane) | | | | | | | | | | | | |
| Example 10 | D-750 | MR-200 | 75/25 | Paraffin | 60 | 5 | 0.38 | 4.24 | 0.076 | 243 | PP | 50 | 30 | 85 | A | A |
| | | | | (eicosane) | | | | | | | | | | | | |
| Example 11 | D-750 | MR-200 | 75/25 | Paraffin | 60 | 5 | 0.38 | 4.24 | 0.076 | 243 | PP | 50 | 30 | 92 | A | A |
| | | | | (eicosane) | | | | | | | | | | | | |
| Example 12 | D-750 | MR-200 | 75/25 | Paraffin | 90 | 5 | 0.07 | 4.56 | 0.014 | 243 | PP | 50 | 45 | 118 | B | A |
| | | | | (eicosane) | | | | | | | | | | | | |
| Example 13 | D-750 | MR-200 | 75/25 | Paraffin | 80 | 5 | 0.16 | 4.68 | 0.032 | 243 | PP | 50 | 40 | 105 | A | A |
| | | | | (eicosane) | | | | | | | | | | | | |
| Example 14 | D-750 | MR-200 | 75/25 | Paraffin | 70 | 5 | 0.26 | 4.48 | 0.052 | 243 | PP | 50 | 35 | 95 | A | A |
| | | | | (eicosane) | | | | | | | | | | | | |
| Example 15 | D-750 | MR-200 | 75/25 | Paraffin | 50 | 5 | 0.34 | 3.92 | 0.108 | 243 | PP | 50 | 25 | 66 | A | A |
| | | | | (eicosane) | | | | | | | | | | | | |
| Example 16 | D-750 | MR-200 | 75/25 | Paraffin | 60 | 1 | 0.08 | 0.84 | 0.08 | 243 | PP | 50 | 30 | 75 | B | A |
| | | | | (eicosane) | | | | | | | | | | | | |
| Example 17 | D-750 | MR-200 | 75/25 | Paraffin | 60 | 3 | 0.23 | 2.54 | 0.077 | 243 | PP | 50 | 30 | 97 | A | A |
| | | | | (eicosane) | | | | | | | | | | | | |
| Example 18 | D-750 | MR-200 | 75/25 | Paraffin | 60 | 4 | 0.31 | 3.38 | 0.078 | 243 | PP | 50 | 30 | 79 | A | A |
| | | | | (eicosane) | | | | | | | | | | | | |
| Example 19 | D-750 | MR-200 | 75/25 | Paraffin | 60 | 10 | 0.77 | 8.46 | 0.077 | 243 | PP | 50 | 30 | 82 | A | A |
| | | | | (eicosane) | | | | | | | | | | | | |
| Example 20 | D-750 | MR-200 | 75/25 | Paraffin | 60 | 5 | 0.38 | 4.24 | 0.076 | 243 | PE | 50 | 30 | 83 | A | A |
| | | | | (eicosane) | | | | | | | | | | | | |
| Example 21 | D-750 | MR-200 | 75/25 | Paraffin | 60 | 5 | 0.38 | 4.24 | 0.076 | 243 | ABS | 50 | 30 | 77 | A | A |
| | | | | (eicosane) | | | | | | | | | | | | |
| Example 22 | D-750 | MR-200 | 75/25 | Paraffin | 60 | 5 | 0.38 | 4.24 | 0.076 | 243 | Plastomer | 50 | 30 | 82 | A | A |
| | | | | (eicosane) | | | | | | | | | | | | |
| Example 23 | D-750 | MR-200 | 75/25 | Paraffin | 60 | 5 | 0.38 | 4.24 | 0.076 | 243 | PP | 30 | 42 | 110 | A | B |
| | | | | (eicosane) | | | | | | | | | | | | |
| Example 24 | D-750 | MR-200 | 75/25 | Paraffin | 60 | 5 | 0.38 | 4.24 | 0.076 | 243 | PP | 40 | 36 | 95 | A | A |
| | | | | (eicosane) | | | | | | | | | | | | |
| Example 25 | D-750 | MR-200 | 75/25 | Paraffin | 60 | 5 | 0.38 | 4.24 | 0.076 | 243 | PP | 70 | 18 | 47 | A | A |
| | | | | (eicosane) | | | | | | | | | | | | |

| Comparative | Example 1 of JP2019-137723A (A melamine resin is used as a | | | | | | | >280 | Plastomer | 20 | 30 | 38 | A | C |
|---|---|---|---|---|---|---|---|---|---|---|---|---|---|---|
| Example 1 | wall material of the capsule wall) | | | | | | | | | | | | | |
| Comparative | Example 6 of JP2019-219518A (Silica is used as a heat storage material particle) | | | | | | | >280 | PP | 40 | 30 | 41 | A | C |
| Example 2 | | | | | | | | | | | | | | |
| Comparative | Example 10 of JP2007-284517A | Paraffin | 80 | 2.2 | 0.05 | 2.10 | 0.021 | 240 | PVA | 8 | 74 | 132 | B | C |
| Example 3 | | (eicosane) | | | | | | | | | | | | |

[symbol]

indicates data missing or illegible when filed

As shown in Table 1, it has been confirmed that the resin pellet according to the embodiment of the present invention exhibits a desired effect.

From the comparison between Example 1 and other Examples, it has been confirmed that a resin has a more excellent effect in a case where the resin has a polymethylenepolyphenyl structure.

From the comparison among Examples 2 to 6, it has been confirmed that in a case where the mass AB is 90/10 to 30/70 (preferably 85/15 to 40/60), the effect is more excellent.

From the comparison between Examples 4 and 7, it has been confirmed that in a case of the aromatic diisocyanate, the effect is more excellent.

From the comparison among Examples 16 to 19, it has been confirmed that in a case where the thickness of the capsule wall of the microcapsules is 0.10 to 5.0 μm, the effect is more excellent.

From the results of Example 15, it has been confirmed that in a case where 6/D is 0.100 or less, the effect is more excellent.

From the results of Example 23, it has been confirmed that the in a case where the content of the thermoplastic resin with respect to the total mass of the resin pellet is 35% by mass or more, the tensile elastic strength is more excellent.

From the results of Example 25, it has been confirmed that in a case where the content of the heat storage material with respect to the total mass of the resin pellet is 20% by mass or more, the heat storage property is excellent.

### EXPLANATION OF REFERENCES

10: microcapsule
10a: capsule wall
10b: encompassed material
12: thermoplastic resin
13: resin pellet

What is claimed is:

1. A resin pellet comprising:
a microcapsule encompassing a heat storage material; and
a thermoplastic resin,
wherein a content of the heat storage material is 70% by mass or less with respect to a total mass of the resin pellet, and
a capsule wall of the microcapsule contains at least one resin selected from the group consisting of polyurethane urea, polyurethane, and polyurea.

2. The resin pellet according to claim 1,
wherein the capsule wall of the microcapsule contains polyurethane urea.

3. The resin pellet according to claim 1,
wherein a total content of the microcapsule and the thermoplastic resin is more than 90% by mass with respect to the total mass of the resin pellet.

4. The resin pellet according to claim 1,
wherein the resin contained in the capsule wall of the microcapsule has a structure represented by Formula (Y), 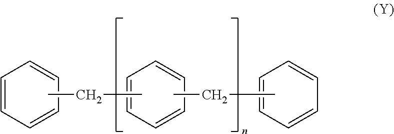
n represents an integer of 1 or more.

5. The resin pellet according to claim 1,
wherein the resin contained in the capsule wall of the microcapsule is a resin obtained by reacting
an aromatic or alicyclic diisocyanate,
a compound having three or more active hydrogen groups in one molecule, and
a polymethylenepolyphenyl polyisocyanate.

6. The resin pellet according to claim 5,
wherein the compound having three or more active hydrogen groups in one molecule is a polyol having a molecular weight of 500 or less.

7. The resin pellet according to claim 1,
wherein the resin contained in the capsule wall of the microcapsule is formed from
a trifunctional or higher functional polyisocyanate A which is an adduct of an aromatic or alicyclic diisocyanate and a compound having three or more active hydrogen groups in one molecule, and
a polyisocyanate B selected from the group consisting of an aromatic diisocyanate and a polymethylenepolyphenyl polyisocyanate.

8. The resin pellet according to claim 1,
wherein a thermal decomposition temperature of the capsule wall of the microcapsule is 200° C. or higher.

9. The resin pellet according to claim 1,
wherein a thickness of the capsule wall of the microcapsule is 0.10 to 5.0 μm.

10. The resin pellet according to claim 1,
wherein an average inner diameter of the microcapsules is 200 μm or less.

11. The resin pellet according to claim 1,
wherein a melting point of the thermoplastic resin is 110° C. or higher.

12. The resin pellet according to claim 1,
wherein the thermoplastic resin is a water-insoluble resin.

13. A manufacturing method for the resin pellet according to claim 1, the manufacturing method comprising:
melting and kneading the thermoplastic resin in an extruder, adding the microcapsule to a melt of the thermoplastic resin in the extruder, followed by further melting and kneading, and cutting a strand extruded from the extruder to manufacture the resin pellet.

14. A molded product that is formed of the resin pellet according to claim 1.

15. An automobile part that is formed of the resin pellet according to claim 1.

16. An electronic apparatus part that is formed of the resin pellet according to claim 1.

17. A fiber that is formed of the resin pellet according to claim 1.

18. The resin pellet according to claim 2,
wherein a total content of the microcapsule and the thermoplastic resin is more than 90% by mass with respect to the total mass of the resin pellet.

19. The resin pellet according to claim 2,
wherein the resin contained in the capsule wall of the microcapsule has a structure represented by Formula (Y), 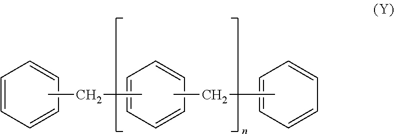
n represents an integer of 1 or more.

20. The resin pellet according to claim 2,
wherein the resin contained in the capsule wall of the microcapsule is a resin obtained by reacting
an aromatic or alicyclic diisocyanate,
a compound having three or more active hydrogen groups in one molecule, and
a polymethylenepolyphenyl polyisocyanate.
